(19) United States
(12) Patent Application Publication
(10) Pub. No.: US 2025/0386167 A1
(43) Pub. Date: Dec. 18, 2025

(54) Multi-Functional Trackable Device System for Asset Monitoring and Location Tracking

(71) Applicant: Lawrence Brandon Smith III, Houston, TX (US)

(72) Inventor: Lawrence Brandon Smith III, Houston, TX (US)

(73) Assignee: Lawrence Brandon Smith III, Houston, TX (US)

(21) Appl. No.: 19/236,552

(22) Filed: Jun. 12, 2025

Related U.S. Application Data
(60) Provisional application No. 63/659,645, filed on Jun. 13, 2024.

(51) Int. Cl. H04W 4/029; G08B 21/24; H04W 4/021; H04W 12/08; H04W 12/64

(52) U.S. Cl. CPC H04W 4/029; G08B 21/24; H04W 4/021; H04W 12/08; H04W 12/64

(57) ABSTRACT

Embodiments of the present invention provide a trackable device system comprising a modular housing integrated with personal or enterprise assets. The system includes a chipset with wireless communication modules (e.g., BLE, UWB, GPS, or cellular), a processor, location modules, memory, and power management components. The processor supports proximity detection, geofencing, motion-triggered alerts, lost-mode activation, and SOS signaling to emergency contacts. Integration with mobile platforms enables real-time tracking, augmented reality overlays, and compatibility with networks like Apple Find My™ and Google Find My Device. Security features include encrypted memory, tamper detection, secure pairing, and a secure enclave for sensitive data. In enterprise settings, the system supports blockchain-based inventory logging, role-based access, and RFID/NFC inventory control. The device adapts to diverse form factors and deployment scenarios, ensuring reliable location tracking, anti-tamper protection, and secure asset management for consumer, industrial, and institutional applications.

### CROSS-REFERENCE TO RELATED APPLICATIONS

The present non-provisional application claims the benefit of priority to provisional patent application No. 63/659,645, filed Jun. 13, 2024, entitled METHOD, DEVICE, AND SYSTEM FOR CONTROL TRACKING OF TRACKABLE DEVICES.

### FIELD OF THE INVENTION

The present invention relates to the field of trackable device systems, and more particularly to modular, multifunctional tracking devices equipped with wireless communication technologies such as BLE, UWB, GPS, and NFC. The invention further encompasses systems integrating features like tamper detection, AR interfaces, and blockchain-based inventory management for use across consumer, enterprise, and military applications.

### BACKGROUND OF THE INVENTION

In today's connected world, location-based services and object-tracking technologies have become indispensable across consumer, enterprise, and military domains. Bluetooth Low Energy (BLE), Ultra-Wideband (UWB), Global Navigation Satellite Systems (GNSS), and Near Field Communication (NFC) are widely adopted technologies that facilitate tracking, short-range communication, and secure identification. Despite the availability of various tracking devices in the market, there are still significant limitations in terms of accuracy, ease of use, and security. Many existing solutions do not provide precise location tracking, lack interoperability across different operating systems, and fail to offer robust security features to prevent unauthorized tracking.

Additionally, existing trackers are typically embedded into specific form factors or fixed to surfaces, lacking modularity or adaptability. This limits their ability to be discreetly integrated into or removed from diverse host objects such as eyeglasses, firearms, helmets, chargers, or other mission-critical gear. Moreover, most conventional systems do not include features such as end-to-end encryption, tamper detection, dynamic configuration, or dual-mode tracking via proprietary, tactical communications, secure communications, and third-party networks (e.g., Apple Find My™ or Google Find My Device™). As security, accountability, and rapid situational awareness become increasingly vital, a need exists for a unified, flexible, and secure tracking solution.

Furthermore, traditional tracking systems often fail in challenging or hostile environments where satellite signals may be blocked, power sources are limited, or unauthorized tracking must be avoided. Military, law enforcement, and high-security enterprise users demand resilient solutions with offline capabilities, anti-tracking safeguards, emergency communication protocols, and compatibility with encrypted command platforms. The need to maintain visibility and control over valuable assets, while avoiding unauthorized surveillance or interference, is more critical than ever.

Current products also lack user-centric integration with augmented reality (AR) interfaces, contextual sensing, and seamless cloud connectivity. Enterprise and military operators are increasingly leveraging AR-based head-up displays (HUDs), real-time inventory management systems, and geospatial dashboards. Without direct AR integration or support for authenticated access and logging through blockchain or cloud APIs, existing trackers are inadequate for high-fidelity, interactive monitoring systems.

Accordingly, there is a clear need for a modular, multifunctional, and highly secure trackable device system that overcomes the limitations of current tracking devices by offering a modular, multifunctional system that unifies secure communication, location accuracy, environmental awareness, user privacy, and configurability into a single deployable module. Accordingly, the present invention addresses these deficiencies by offering a universal system adaptable to a wide range of form factors, equipped with multi-protocol communication capabilities, advanced security features, tamper detection, and compatibility with both proprietary and public tracking networks. The invention further supports future-proof use cases including integration with AR, smart home systems, and decentralized asset verification platforms.

### OBJECTS OF THE INVENTION

The primary object of the present invention is to provide a modular, multifunctional trackable device system capable of being embedded within or attached to various host objects such as eyeglasses, firearms, helmets, chargers, rifle scopes, containers, or wearable accessories.

Another object of the invention is to enable seamless and highly accurate object tracking by incorporating a combination of communication protocols including Bluetooth Low Energy (BLE), Ultra-Wide Broadband (UWB), Global Navigation Satellite Systems (GNSS), Near Field Communication (NFC), and optional cellular connectivity.

A further object is to ensure secure and private usage by implementing encrypted communication, blockchain-based ownership registration, and unauthorized tracking detection and prevention mechanisms.

Yet another object is to provide real-time alerts, geofencing, and anti-tamper detection capabilities, allowing users to receive notifications when a host object is moved, separated, or compromised.

An additional object is to support compatibility with third-party object tracking and recovery platforms such as Apple's Find My™ and Google's Find My Device™ networks while retaining standalone operational capabilities through a proprietary software interface.

Another object is to offer flexible power management options including rechargeable batteries, wireless charging, and optional solar panels to support long-term deployment in diverse environments.

Still, another object is to enable enhanced user interaction and situational awareness by integrating augmented reality (AR) interfaces, wearable displays, or audio prompts for locating or identifying tracked objects.

A further object is to provide robust environmental sensing and contextual monitoring by embedding sensors such as accelerometers, gyroscopes, temperature, humidity, and proximity detectors into the modular device.

Yet another object is to support enterprise and military-grade use cases through advanced inventory tracking, role-based access control, audit trails, and real-time team coordination.

Yet another object is to allow customizable device configurations and firmware updates via wireless communication to adapt to various user needs, regulatory environments, or application-specific scenarios.

### SUMMARY OF THE INVENTION

According to a first aspect of the present invention, a trackable device system is provided. The trackable device system comprising: a housing configured to be integrated with or attached to an asset; a communication module embedded in the housing configured to wirelessly communicate with a user device over a network through an encrypted communication protocol to prevent unauthorized access; a tracking module embedded in the housing configured to determine a location data of the asset; a processor configured to pair with a mobile application on the user device and transmits location data of the asset to the mobile application; wherein the mobile application is configured to: monitor proximity of the asset and trigger an alert upon separation unless a predefined safe zone is detected; track and display location of the asset; engage a geo-fence protocol and transmit an alert when the asset enters or exits a pre-defined virtual boundary.

In one embodiment of the invention, the communication module includes at least a Bluetooth, Bluetooth Low Energy (BLE), a Wi-Fi modem, a cellular modem, or a combination thereof.

In one embodiment of the invention, the tracking module includes at least a GPS, GNSS, a UWB transceiver, a location-based Wi-Fi, or a combination thereof.

In one embodiment of the invention, the mobile application track and display location of the asset in 2D, 3D, and augmented reality overlays.

In one embodiment of the invention, the geo-fence protocol allows dynamic creation or deletion of boundaries using the mobile application.

In one embodiment of the invention, the mobile application is further configured to detect separation from a base station, a host platform, or the user device and log the timestamped location data of the asset on occurring of a separation event.

In one embodiment of the invention, the housing further comprises an accelerometer configured to transmit motion data to the mobile application on the user device, the user device transmits an alert when motion of the asset is detected.

In one embodiment of the invention, entering or exiting the pre-defined safe zone triggers a status change in the asset, including generation and suppression of notifications.

According to a second aspect of the present invention, a secure, trackable device system for asset management is provided. The secure, trackable device system for asset management comprising: a housing configured to be attached to an asset; a communication module embedded in the housing configured to wirelessly communicate with a user device over a network through an encrypted communication protocol to prevent unauthorized access; a tracking module embedded in the housing configured to determine a location data of the asset; a memory configured to store a unique identifier for the asset and encrypted log data; a processor configured to: establish communication with inventory management platform through a localized encrypted network; enable communication with one or more pre-authorized assets within the encrypted network; selectively advertise the presence of the asset to the inventory management platform.

In one embodiment of the invention, the memory comprises encrypted flash memory and a secure enclave for storing sensitive data including cryptographic keys and user credentials.

In one embodiment of the invention, the memory stores encrypted log data comprising timestamps, geolocations, environmental conditions, and asset state, and is capable of uploading such logs to the secure inventory management platform.

In one embodiment of the invention, the asset is registered to a distributed ledger that logs assignments, transfers, and custody status using a blockchain-based infrastructure.

In one embodiment of the invention, the distributed ledger is accessible through a secure permissioned blockchain network and provides audit logs for authorized users.

In one embodiment of the invention, each of the asset is associated with a unique identifier and assigned to individual users, organizational groups.

In one embodiment of the invention, the system further comprising a RFID or NFC tag embedded in the asset, enabling contactless asset detection and inventory logging.

In one embodiment of the invention, the tracking system supports multi-tier visibility, allowing role-based access to devices across units, teams, or departments.

According to a third aspect of the present invention, trackable device system for enabling peer-to-peer detection is provided. The system comprising: a plurality of trackable devices attached to a plurality of assets, wherein each of the plurality of trackable device comprises a communication module and a tracking module; wherein the plurality of trackable device communicate using a shared communication protocol Bluetooth GATT with other device; wherein each of the plurality of trackable device comprises a response actuator configured to perform a predefined physical response; wherein a first trackable device is configured to detect the presence of a second trackable device within communication range and transmit a command to activate the response actuator on the second trackable device.

In one embodiment of the invention, the system further comprises a mobile application in a user device in communication with the plurality of trackable device, wherein the mobile application is configured to: identify and establish a communication with the plurality of trackable device; initiate, through the first trackable device, a detection scan for the second trackable device within a communication range; cause the first trackable device to transmit a triggering command to the second trackable device using the Bluetooth GATT protocol, the command configured to activate the response actuator on the second trackable device; wherein the triggering occurs without location services or a cloud-based infrastructure.

In one embodiment of the invention, the plurality of trackable devices is configured to operate on a same or a different tracking network.

In one embodiment of the invention, the response actuator triggers a physical response that includes but is not limited to emitting an audible alert, vibrating or flashing a light.

In the context of the specification, the term “Trackable device” refers to a portable electronic module that can transmit and/or receive location signals for the purpose of determining its location or status, particularly in the event of loss, misplacement, theft, or deployment in operational settings. The device may be embedded in or attached to host objects such as personal belongings, tools, vehicles, or personnel equipment.

In the context of the specification, the term “Bluetooth Low Energy (BLE)” refers to a wireless communication protocol based on the Bluetooth Core Specification (typically version 4.0 or later), optimized for low power consumption and short-range data exchange. In this context, BLE is used for advertising device identifiers, enabling proximity detection, pairing with smartphones, and facilitating encrypted communication for location reporting or control.

In the context of the specification, the term “Bluetooth tracking network” refers to a decentralized or crowdsourced tracking system (e.g., Apple's Find My™ or Google's Find My Device™) in which BLE signals from a trackable device are anonymously detected by nearby first party and third-party smartphones or devices, which relay the trackable device's presence and approximate geolocation to a cloud service accessible by the device owner.

In the context of the specification, the term “Ultra-Wideband (UWB)” refers to a radio technology that uses very short pulses over a wide frequency spectrum to enable high-precision distance and angle measurements between two or more devices. UWB enables centimeter-level ranging and spatial orientation and may be used for indoor positioning, directional tracking, and real-time object finding.

In the context of the specification, the term “Global Positioning System (GPS)” refers to the U.S.-based satellite navigation system, and “Global Navigation Satellite System (GNSS)” refers more broadly to systems including GPS, GLONASS (Russia), Galileo (EU), BeiDou (China), or regional systems. These systems provide absolute geolocation data, particularly in outdoor environments, for tracking the position of the device.

In the context of the specification, the term “Geofence” refers to a virtual geographic boundary defined by GPS or other location services, which triggers an alert or automated action when the tracked device enters or exits the defined area.

In the context of the specification, the term “Tamper detection” refers to the detection of unauthorized physical access, damage, or alteration of the trackable device or its enclosure. Tamper detection may be accomplished using sensors (e.g., pressure sensors, light sensors, contact switches, accelerometers), circuit integrity monitoring, or the detection of mechanical disassembly. Tamper events may result in alerts, data encryption, location locking, or system lockdowns.

In the context of the specification, the term “Pairing” refers to the process of establishing a secure communication link between a trackable device and a user's mobile device or platform. This typically involves device authentication and exchange of cryptographic keys, and results in exclusive or authorized control of the trackable device.

In the context of the specification, the term “Lost Mode” refers to an operational state in which a trackable device has been designated as missing by the user or administrator. In Lost Mode, the device may activate enhanced visibility features (e.g., beaconing at a higher frequency, activating NFC), provide contact information to third-party finders, restrict unauthorized use, and/or trigger tamper or motion alarms.

In the context of the specification, the term “NFC (Near Field Communication)” refers to a short-range communication protocol (typically <10 cm) that allows data exchange between devices when in close proximity. NFC is used in the context of this invention to allow a finder to interact with a lost device by tapping it with a smartphone of NFC-read capable device, thereby retrieving information such as contact instructions or ownership metadata.

In the context of the specification, the term “Audible alert” refers to a sound emitted by the trackable device, typically generated by an integrated piezoelectric speaker or buzzer, to assist in locating the device when it is within hearing range.

In the context of the specification, the term “Control button” or “activation button” refers to a physical interface element on the trackable device, used to trigger pairing mode, reset, power on/off, or manual location signaling.

In the context of the specification, the term “Secure enclave” or “hardware root of trust” refers to a dedicated secure subsystem within the trackable device used for storage of cryptographic keys, digital certificates, and device identity credentials, enabling end-to-end encryption and preventing unauthorized firmware access.

In the context of the specification, the term “Tracking application” or “tracking app” refers to a software interface (mobile app, desktop app, or web interface) that allows users to pair with, monitor, configure, and locate one or more trackable devices. The application may provide live maps, UWB directional indicators, AR overlays, or notification management tools.

In the context of the specification, the term “Crowdsourced tracking” refers to the detection of a lost device by third-party users' smartphones or connected devices (not owned by the device's primary user) and the relaying of its location to a centralized service for owner access. This enables finding lost devices even when the owner is not nearby.

In the context of the specification, the term “Modular architecture” refers to the design of the trackable device system in a manner that allows its core components to be integrated into or mounted onto a wide variety of host products across different industries, without requiring a redesign of the entire electronic stack.

In the context of the specification, the term “Environmental sensor” refers to a sensor capable of detecting temperature, humidity, shock, motion, or other physical conditions, optionally used to log or respond to environmental events relevant to the use case (e.g., excessive heat exposure, drop detection, or motion in unauthorized zones).

In the context of the specification, the term “Encrypted identifier” refers to a cryptographically secured signal broadcast by the trackable device, which represents its unique identity in a manner that cannot be reverse-engineered by unauthorized receivers, ensuring privacy and preventing tracking by malicious actors.

In the context of the specification, the term “Findable network” refers to any system of interconnected devices, either proprietary or cross-platform, that is capable of detecting the presence of a trackable device and securely reporting its location to an authorized user.

### BRIEF DESCRIPTION OF THE ACCOMPANYING DRAWINGS

The accompanying drawings illustrate the best mode for carrying out the invention as presently contemplated and set forth hereinafter. The present invention may be more clearly understood from a consideration of the following detailed description of the preferred embodiments taken in conjunction with the accompanying drawings wherein like reference letters and numerals indicate the corresponding parts in various figures in the accompanying drawings, and in which:

### BRIEF DESCRIPTION OF THE DRAWINGS

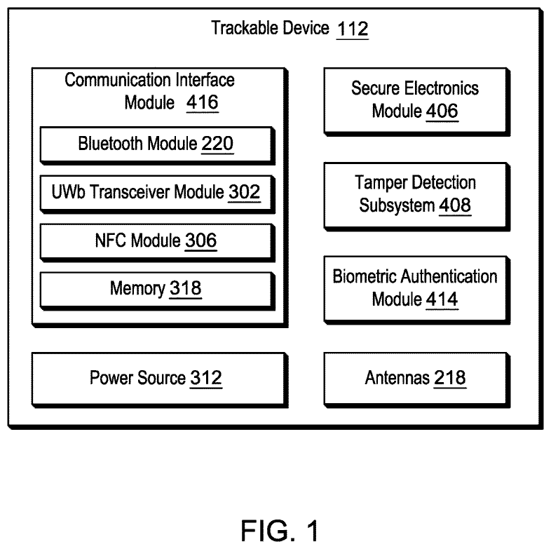

FIG. 1 is a block diagram of the trackable device for real-time tracking, secure identification, and tamper resistance in high-security use cases, in accordance with an embodiment of the present invention.

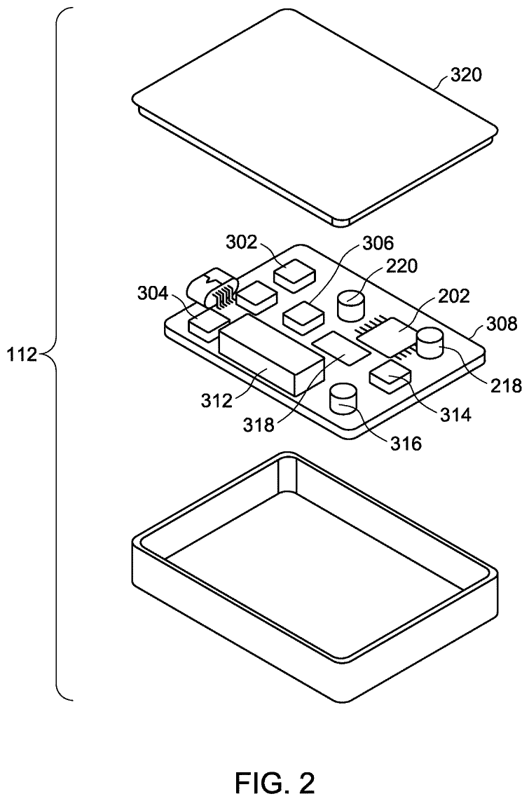

FIG. 2 shows an exploded view of the internal architecture of the modular trackable device, clearly illustrating the arrangement and interconnection of its principal internal components, in accordance with an embodiment of the present invention.

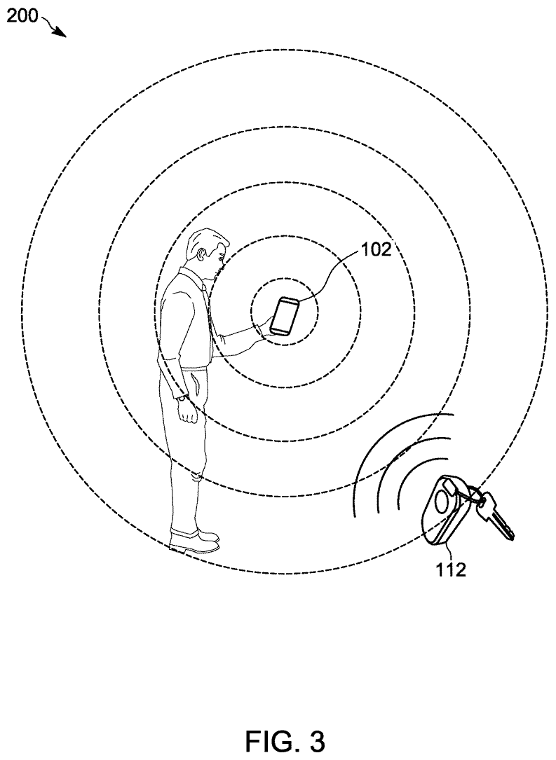

FIG. 3 shows an exemplary environment depicting a connection between a user device and a trackable device, in accordance with an embodiment of the present invention.

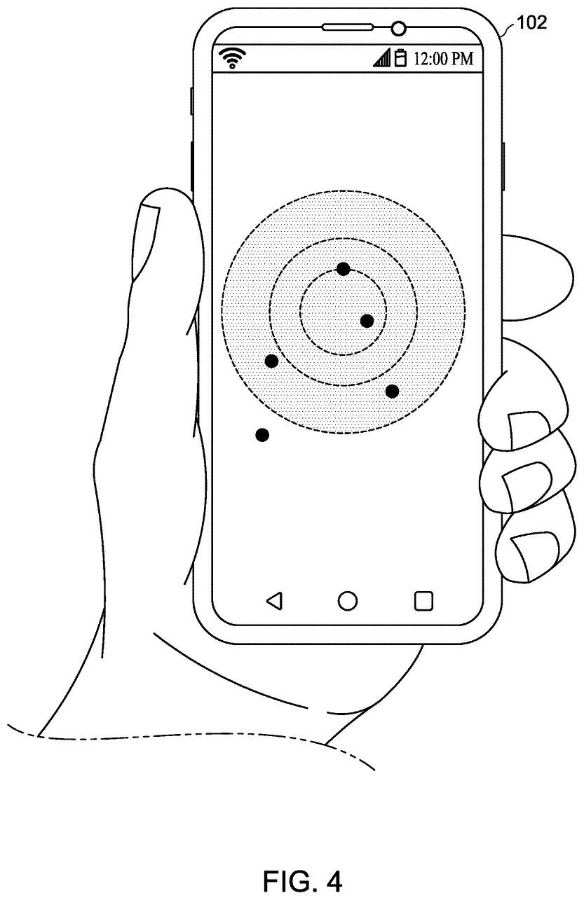

FIG. 4 illustrates an exemplary diagram representing the geofencing functionality of the modular trackable device system, in accordance with an embodiment of the present invention.

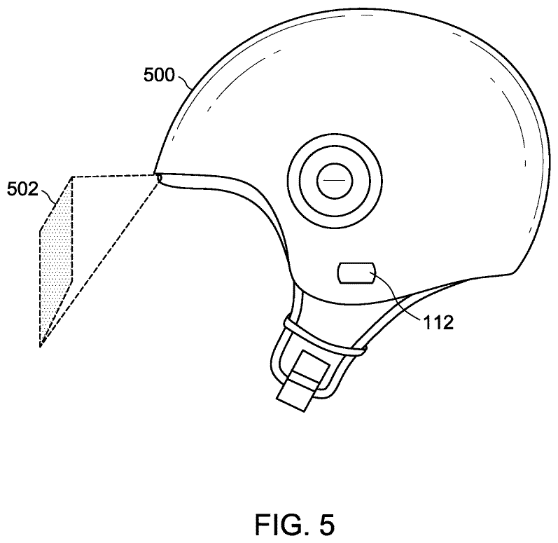

FIG. 5 illustrates the trackable device configured to interface with an augmented reality system embedded in or coupled to a helmet, enabling real-time navigation, team coordination, and object localization functionalities in accordance with an embodiment of the present invention.

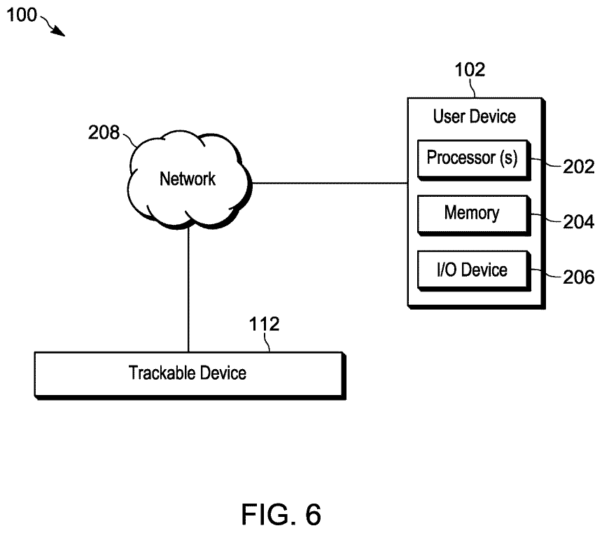

FIG. 6 is a block diagram of a trackable device system illustrating components of a trackable device system, in accordance with an embodiment of the present invention.

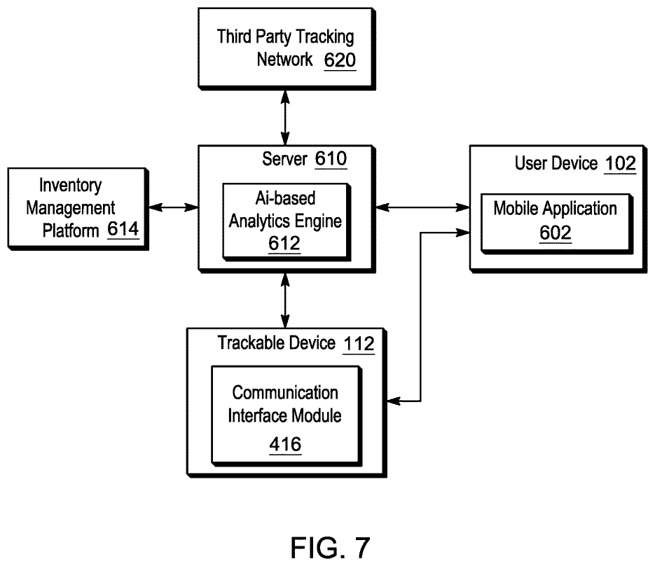

FIG. 7 represents a system-level diagram of the communication architecture of the trackable device, in accordance with an embodiment of the present invention.

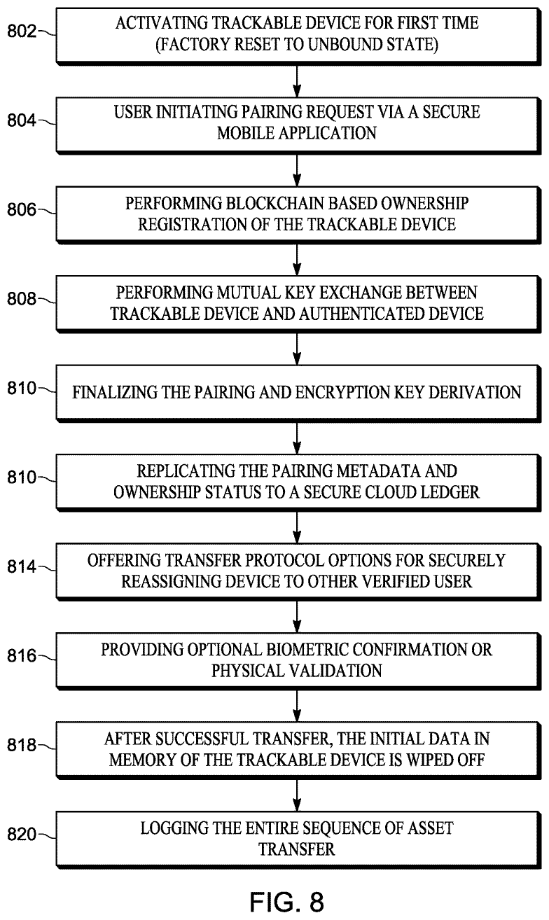

FIG. 8 is a flowchart showing a method illustrating the ownership binding and transfer process for the modular trackable device using a secure, decentralized blockchain registration protocol, robust encryption mechanisms, and authenticated pairing steps, in accordance with an embodiment of the present invention.

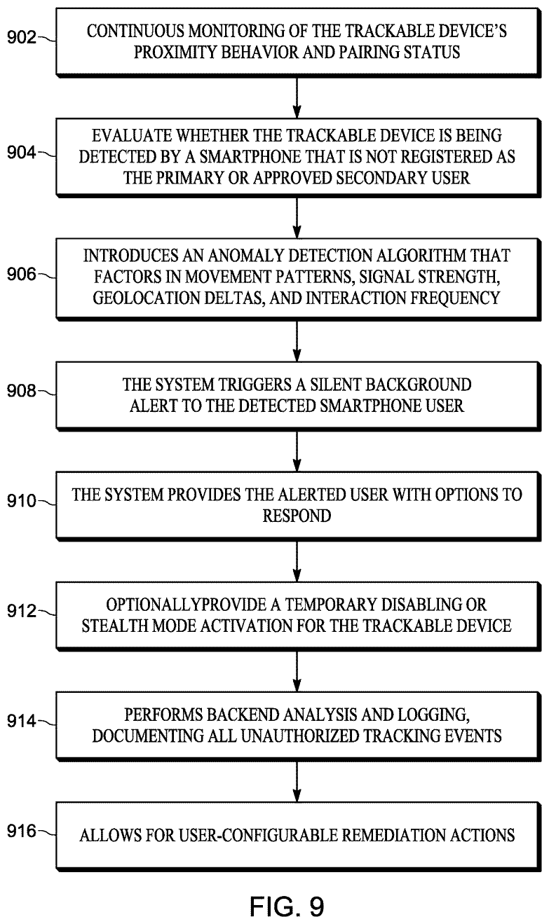

FIG. 9 is a flowchart showing a method for detecting and mitigating unauthorized tracking by the trackable device, in accordance with an embodiment of the present invention.

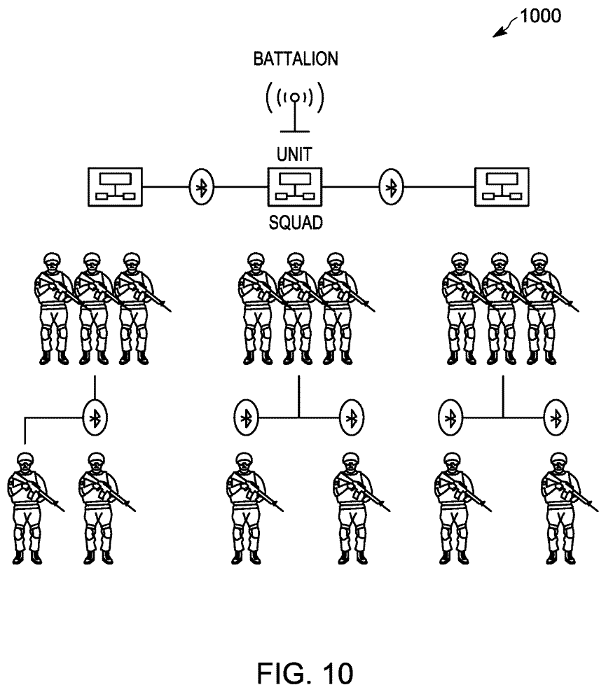

FIG. 10 illustrates the operational visibility and control through a multi-level, network-connected system architecture unit of the trackable device, in accordance with an embodiment of the present invention.

### DETAILED DESCRIPTION

Embodiments of the present invention disclosure will be described more fully hereinafter with reference to the accompanying drawings in which like numerals represent like elements throughout the figures, and in which example embodiments are shown.

The detailed description and the accompanying drawings illustrate the specific exemplary embodiments by which the disclosure may be practiced. These embodiments are described in detail to enable those skilled in the art to practice the invention illustrated in the disclosure. It is to be understood that other embodiments may be utilized, and other changes may be made, without departing from the spirit or scope of the present disclosure. The following detailed description is therefore not to be taken in a limiting sense, and the scope of the present invention disclosure is defined by the appended claims. Embodiments of the claims may, however, be embodied in many different forms and should not be construed as limited to the embodiments set forth herein.

Embodiments of the present invention provide a modular trackable device system designed for integration with or attachment to various physical host objects, including but not limited to helmets, rifles, apparel, containers tools, and personal accessories. The trackable device can be deployed as a standalone tracker or integrated into various physical carriers. The trackable device integrates advanced tracking, communication, security, and sensing features for diverse applications across consumer, enterprise, and military domains. The invention provides a unified architecture of the trackable device enabling robust location tracking, encrypted communication, tamper detection, and intelligent context-aware interactions across various operational environments.

The trackable device system comprises at least one trackable device and a user device configured to execute a companion mobile software application. The user device may be a smartphone, smartwatch, a tablet, or other smart computing platform with wireless communication capabilities including Bluetooth, Wi-Fi, UWB, GPS and NFC. The user device is configured to pair with, monitor and control the trackable device and optionally connect to a cloud server to provide secure registration, location history, remote configuration, and anti-theft measures.

The trackable device comprises a compact, ruggedized electronic module enclosed within a sealed housing that meets industry durability and ingress protection standards, such as IP67 or MIL-SD-810. The core of the trackable device is a low-power microcontroller unit (MCU)/processor, which acts as the central processing hub. The MCU is typically an ARM Cortex-M-based System on a chip, featuring integrated cryptographic hardware for secure key management, encrypted communication, and firmware authentication. The processor operations such as signal broadcasting, encrypted communication, sensor data handling, battery management, and user interaction (e.g., via a button or control switch), via a structured firmware architecture that utilizes I2C, SPI, UART, and GPIO interfaces.

The trackable device is powered by a power source. The power source can be a rechargeable battery, typically lithium-polymer or solid-state), governed by a smart battery management IC (BMIC). The subsystem supports multiple charging modalities, including wireless charging via the Qi standard, USB-C wired input, and optionally, solar energy harvesting via a photovoltaic panel integrated into the housing. A power management module regulates voltage supply across the device's communication, processing, and sensing subsystems.

The trackable device comprises a communication interface module that allows the trackable device to communicate with the user device, other trackable devices, a UWB anchor, a base station, or any other device. The communication interface comprises one or more or a combination of several interoperable modules.

In an embodiment, the communication interface module of the trackable device comprises a Bluetooth Low Energy (BLE) transmitter and receiver to send and receive Bluetooth signal, enabling wireless communication with the user device. The trackable device further comprises a plurality of antennas to enhance the device's connectivity and range.

The BLE (Bluetooth Low Energy) chipset of the trackable device is configured to act as the primary communication module. The BLE transmits a unique, encrypted identifier using BLE advertisements. These identifiers can be received by the user device (a smartphone) or a third party participating in Bluetooth tracking networks, such as Apple's Find My or Google's Find My Device services. Upon reception, the receiving device uploads the detected beacon and its geolocation to a secure cloud server. The owner of the lost or tracked item can access the updated location via a native OS tracking interface, a dedicated cross-platform app, or network based website. The system supports real-time or asynchronous tracking, depending on the connectivity and network availability.

To supplement BLE tracking and enhance positional accuracy, the module may include an Ultra-Wideband (UWB) chip. This chip facilitates high-precision ranging by calculating the time of flight and angle of arrival of RF pulses exchanged between the UWB module and a UWB-capable smartphone or base station. Unlike BLE, which provides proximity estimates based on signal strength (RSSI), UWB provides centimeter-level spatial awareness, making it especially useful in cluttered, GPS-denied, or indoor environments. The application interface on the mobile device may render UWB data in the form of compass-like indicators, directional arrows, or augmented reality (AR) overlays that guide the user to the lost object.

In an embodiment of the present invention, the trackable device includes an IEEE 802.15.4z-compliant UWB transceiver supporting time-of-flight (ToF) and angle-of-arrival (AoA) measurements. The system performs trilateration or multi-lateration using ranging data between the user device and the trackable device, with updates occurring every few milliseconds to produce real-time feedback. The UWB signal pulses are extremely short (on the order of nanoseconds) and spread across a wide spectrum (3.1 to 10.6 GHz), making them resilient to multipath interference and suitable for dense environments.

A Kalman filter or extended Kalman filter (EKF) may be implemented within the companion mobile application on the user device to fuse sensor data from the smartphone's inertial measurement unit (IMU) with UWB-ranging measurements, producing smooth, high-resolution positioning. In AR-enabled tracking modes, the application overlays a 3D directional arrow or object trail within a real-world camera view to guide users toward the trackable device. Azimuth and elevation angles are calculated from phase difference of arrival (PDoA) or antenna array interpolation, enabling vertical differentiation in multistorey structures.

In an embodiment, the trackable device comprises one or more location-determining modules, such as GPS, and GNSS to determine the coordinates of the location of the trackable device. The GNSS receiver supports multiple satellite constellations, such as GPS, GLONASS, Galileo, and BeiDou, and is capable of hybrid positioning when coordinated with BLE and UWB data, especially useful in transitional environments like parking structures or semi-indoor areas.

In an embodiment, the trackable device may further comprise a Near Field Communication (NFC) module to allow secure short-range interactions. For instance, when the device is placed in “Lost Mode,” its NFC tag becomes readable by any smartphone with NFC support. A finder who taps their phone to the item can view a customized message stored on a secure server, such as contact details, instructions for return, or a request for assistance. This implementation is privacy-conscious and allows recovery of lost property without disclosing the owner's identity unless explicitly permitted.

The communication interface module of the trackable device may further include a cellular modem, the cellular modem offers long-range communication in off-grid or infrastructure-less environments.

In an embodiment, the trackable device pairs with the user device via the user interface. The pairing process allows the trackable device to integrate seamlessly with the Bluetooth tracking network of the user device, enabling a range of functionality. Using a combination of Bluetooth and GPS technologies present in the trackable device and the user device, the device can be tracked globally within Bluetooth range and beyond. The trackable device reports its location to the user device, which is then displayed on the user interface. The user interface can display the location of the trackable device on a map, which can be viewed in 2D, 3D, and satellite views, showing the last or updated location of the trackable device.

In an embodiment of the present invention, the companion mobile application comprises a modular architecture with layers including a user interface (UI), device control logic, network communication, encryption library, and cloud synchronization module. The application is compatible with iOS and Android platforms and is built using a reactive framework for real-time updates.

The companion mobile application on the user device or smartphone enables a user to view the real-time or last known location of the trackable device on a dynamic map with satellite overlays. The UWB-enabled trackable device shows augmented directional arrows for close-range interval. The user is able to define digital perimeters for the trackable device in the companion mobile application. The mobile application notifies the user when the trackable device enters or exists the perimeter or boundary (geo-fence). The companion mobile application is configured to create and prioritize multiple nested or overlapping geo-fences. When a trackable device is lost, it broadcasts BLE advertisements more frequently and enables auditory of vibration feedback. The companion mobile app generates a sharable lost device link or QR code and optionally joins third-party crowdsourced networks (e.g. Apple Find my Device, Google Find my Device) to expand recovery reach. Any attempt to reset or de-pair the lost device by unauthorized users trigger audible alarms and lockout timer in the mobile application. The mobile application continuously monitors RSSI and motion states. When the device is detected moving away from the user's phone beyond a configurable distance threshold, an alert is triggered. In advance mode, the mobile application allows for threshold based on activity, such as walking, driving. All device logs, location histories, and alert data are synced to a secure cloud platform. The mobile application can be used to push the firmware updates to the trackable device using OTA (over-the-air) mechanism. The mobile application can be used to share the trackable device with other trusted users by setting permission levels, such as view-only, sound activation, or full control. In case of smartwatches, a minimalist version of the companion application can be used that allows features such as triggering alerts, viewing last known location and receiving separate notifications, etc.

In an embodiment of the present invention, the companion mobile application may provide advance analytics including heatmaps of frequently visited locations, travel history, and usage statistics. An enterprise dashboard version of the mobile application may allow fleet or inventory managers to monitor hundreds of trackable devices in real-time with hierarchical user access levels and API integration.

The trackable device can be implemented in an automated inventory management system wherein GPS location data transmitted from the Bluetooth-enabled tracking device is automatically processed and integrated into a centralized inventory database without manual user intervention. When the tracking device establishes a Bluetooth connection with a registered gateway device or mobile application, the system automatically captures the current GPS coordinates along with timestamp information and cross-references this location data against predefined geographic zones, facility boundaries, or designated storage areas to automatically update the inventory record with the current location status. This autonomous location updating mechanism enables real-time inventory visibility across multiple facilities, warehouses, or deployment sites, allowing organizations to maintain accurate asset location records without requiring manual check-ins, barcode scanning, or physical inventory audits.

In an embodiment, the trackable device system implements multi-layered encryption and security features to prevent unauthorized access, spoofing and tracking. Communication between the trackable device and the user device is secured via AES-256 encryption, with ephemeral session keys during each handshake using Elliptic Curve Diffie-Hellman (ECDH) key exchange. Device identifiers such as MAC addresses are rotated and obfuscated using a rotating identifier scheme (RIS) based on cryptographic tokens, to prevent persistent tracking by third parties.

The trackable device may support forward secrecy, where no single compromised session key compromises the integrity of past or future communication. Each trackable device includes a hardware-based random number generator (TRNG) and a secure enslave or Trusted Execution Environment (TEE) for performing cryptographic operations. Device authentication may rely on a public-private key infrastructure (PKI), where the user device validates the digital signature of the trackable device during registration or lost-mode recovery.

To prevent an unauthorized tracking, the system may detect persistent proximity of unknown trackable devices to the user device and issue alerts through the companion mobile application. This “anti-stalking detection” feature leverages statistical models comparing signal strength (RSSI), encounter duration, and trajectory correlation. When such patterns exceeds thresholds, the user is discreetly notified and offered redemption options such as disabling tracking or submitting a report.

In an embodiment of the present invention, the method of tracking the modular trackable device using the mobile application begins with an initial pairing process wherein the trackable device is securely linked to the user's mobile device via a low-energy wireless protocol such as Bluetooth Low Energy (BLE) or Near Field Communication (NFC). Once paired, the trackable device is registered within the mobile application, which assigns a unique identifier and stores configuration parameters such as geofence settings, update intervals, and security preferences. The trackable device periodically or continuously transmits its positional data using an onboard location technology suite that may include Global Positioning System (GPS), Ultra-Wideband (UWB), BLE signal triangulation, or Wi-Fi/cellular positioning, depending on the operating environment and hardware configuration. When the trackable device is within close proximity, the mobile application may rely on direct BLE communication for location determination, leveraging signal strength (RSSI), round-trip time (RTT), or angle-of-arrival (AoA) data to estimate precise relative distance.

As the trackable device moves, the mobile application actively monitors its location against predefined virtual boundaries, commonly known as geofences, which may be concentric zones or irregular perimeters set by the user. If the trackable device crosses a specified geofence threshold, the application generates a real-time notification alert to the user, which may include auditory, haptic, or visual cues. Depending on the severity of the breach (e.g., a device leaving a critical zone such as a military perimeter or leaving a child's vicinity), the app may also trigger escalation protocols such as remote lockdown, beacon mode activation, or alerting emergency contacts. The geofencing logic may be further refined through contextual intelligence, allowing adaptive thresholds based on environmental density or temporal conditions-shrinking zones during high-density events or expanding them during periods of inactivity.

In addition to location tracking, the mobile application receives auxiliary telemetry data from the trackable device, such as motion, orientation, tamper status, and battery level. This data is displayed on a graphical dashboard within the app, offering users an overview of the device's current and historical status. Users may also initiate manual commands through the app, such as pinging the device to emit a sound or light signal, remotely locking the device in case of unauthorized handling, or sharing temporary tracking access with trusted parties. All interactions and positional updates are logged by the application and may be synchronized with a secure cloud server for backup, analysis, or integration with third-party platforms such as family safety networks, enterprise inventory systems, or smart home environments.

For long-range tracking or loss prevention, the system may leverage mesh networking or integration with large-scale tracking ecosystems such as Apple's Find My™ or Google's Find My Device network, wherein third-party devices relay anonymized positional information to the owner's mobile application. Furthermore, in one embodiment, the mobile application includes a behavioral inference engine that analyzes movement patterns, frequency of use, and contextual inputs (e.g., whether the user is present nearby or not) to detect anomalies suggestive of theft or mishandling, thereby enhancing the reliability and intelligence of the tracking system.

The mobile application acts as a centralized command and monitoring interface for the modular trackable device, enabling seamless, secure, and context-aware tracking of various host objects-including wearables, firearms, helmets, and personal items-across both consumer and professional use cases. The integration of communication, location, and security features into a unified tracking method ensures that users maintain continuous situational awareness and actionable control over their tracked assets.

In an embodiment, the trackable device incorporates a physical user interface component, typically a control button that can be used during the pairing process or for triggering specific modes (e.g., sync, reset, audible alarm). Pressing the button while the module is powered initiates a secure pairing sequence using BLE, during which the device advertises its identity and establishes an encrypted connection with the user's smartphone. Once paired, the device is linked to the user's account, preventing unauthorized resets or reassignments. A small onboard speaker can be actuated remotely through the associated mobile app to emit an audible alert tone, aiding in the location of the device when it is nearby but not visible (e.g., inside furniture or bags).

In an embodiment, to extend reliability, the trackable device system supports remote alert features, such as “Notify When Left Behind.” This feature is configurable within the app and relies on BLE proximity detection to alert the user when a tracked item is no longer within a defined geofence radius. This helps prevent unintentional losses of high-value or mission-critical items in public spaces or during transit.

The trackable device system can also support location sharing among trusted users. Through the associated application interface, the primary owner may authorize multiple users to access specific devices. Permissions may include location viewing, alarm triggering, and Lost Mode activation. Each user's access level can be customized, and all interactions are logged to ensure security. This function is valuable for households, teams, or organizations managing shared tools, bags, weapons, or other trackable equipment.

In an embodiment, the trackable device further comprises a tamper detection system configured to identify unauthorized removal or physical breaches. This is implemented using pressure sensors, light sensors, inertial measurement units (IMUs), or conductive traces along housing seams. If the housing is opened or physically breached, a tamper event is detected. This can trigger several responses, such as disabling location reporting, encrypting local data, or notifying the owner via a secure cloud alert. Upon tamper detection, the system may trigger an alert, lock access to local data, and relay the event through secured channels to an authorized monitoring interface, such as a mobile application or an enterprise dashboard. The tamper detection system is especially important in military or regulatory environments where tampering may indicate security breaches or loss of integrity.

In another embodiment, the trackable device includes dual BLE radios: one for user-facing interactions and another for broadcasting signals to third-party tracking networks. This dual-channel approach ensures that private communications (e.g., syncing with a phone or executing a control command) do not interfere with public beaconing used for location discovery by distributed networks. This enhances the privacy, reliability, and efficiency of tracking.

In a further embodiment, for military or enterprise-grade applications, the UWB module can be used not only for peer-to-peer ranging but also for infrastructure-based triangulation. In such deployments, fixed anchor nodes are installed at known coordinates within facilities like warehouses, military bases, or hospitals. The UWB module communicates with these anchors to compute its real-time location using trilateration algorithms. This is valuable for tracking assets or personnel in GPS-denied zones or indoor environments where BLE accuracy is insufficient.

The GNSS module supports outdoor geolocation through compatibility with global satellite systems including GPS (USA), GLONASS (Russia), Galileo (EU), and BeiDou (China). It may be configured to operate in conjunction with UWB and BLE to create hybrid positioning systems that maintain continuity during environment transitions (e.g., moving from outdoor to indoor areas). Hybrid operation improves tracking fidelity in challenging geospatial conditions.

In an embodiment, the trackable device system supports end-to-end encryption of all location and status data. The system employs hardware root-of-trust and cryptographic processors to encrypt outgoing packets, ensuring secure data exchange with authorized terminals. This is particularly crucial in military applications where adversarial tracking or interception poses operational threats. Each module has a device-specific cryptographic key stored in secure memory, facilitating secure handshake and communication within a known network.

In an embodiment, the trackable device includes an augmented reality (AR) interface module for enhanced spatial interaction. This helps in projecting virtual tracking information into the user's AR interface (e.g., smart glasses), overlaying real-time data such as item status, proximity warnings, directional arrows, or personnel identity overlays. This feature significantly improves situational awareness, particularly in tactical or field maintenance scenarios.

The trackable device system is configured to provide a robust anti-tracking or “unwanted tracking prevention” system. The trackable device system is configured to detect when the device is persistently near an unauthorized or unfamiliar user, using motion profiles and surrounding device scans. Upon triggering, the trackable device may issue periodic audible alerts or transmit anonymized notifications to smartphones in proximity (e.g., using BLE advertisements), thereby alerting individuals to the potential of unauthorized tracking.

In an embodiment, the trackable device is configured for cross-domain use by embedding modular interface connectors or magnetic pogo pins. The modular interface connectors or magnetic pogo pins allow the trackable device to be quickly transferred and electrically interfaced with multiple host objects. For example, a user could detach the trackable device from a rifle and mount it onto a helmet without reconfiguration. The firmware supports dynamic recognition of the host category, adjusting device behavior accordingly.

In an embodiment, the trackable device may further comprise one or more environmental sensors for context-aware tracking. Such sensors may include temperature, humidity, shock, or chemical exposure sensors, and are used for asset condition monitoring, personnel safety tracking, or transport compliance verification. When integrated with cloud-based analytics, the sensor data may trigger workflows, such as sending a replacement request when thermal thresholds are exceeded or generating audit logs for sensitive cargo transport.

In military inventory management, the trackable device supports mesh networking through BLE and UWB modules. This allows the formation of ad hoc communication networks in GPS-denied or infrastructure-less zones. Devices in such a mesh relay encrypted location and status information among units, enhancing troop awareness and real-time asset visibility without requiring cellular or satellite uplinks.

In an embodiment, the trackable device includes a micro solar charging panel integrated into its housing. The micro-solar panel allows passive charging during outdoor use, prolonging operational life in off-grid scenarios. A power optimization algorithm governs charge usage and module duty cycles based on ambient light levels, movement frequency, and communication intensity.

The invention also supports an intelligent alerting system configurable through a mobile or desktop dashboard. Alerts may include geofence exit/entry, battery threshold, tamper events, unauthorized tracking, temperature excursions, or separation from designated host objects. The system offers configurable thresholds, schedules, and multi-user access rights, suitable for enterprise fleet or inventory management.

In certain embodiments, the trackable device supports firmware-over-the-air (FOTA) updates via BLE, NFC, or Wi-Fi interfaces. Secure update mechanisms ensure that only signed and authenticated firmware can be installed, maintaining device integrity and minimizing the risk of cyber intrusion. Update processes may be triggered periodically, or upon connecting to a designated charging station or hub.

In certain embodiments, the trackable device incorporates NFC for short-range pairing, secure authentication, or tap-to-track functionality. NFC may be used to authenticate access to equipment, log personnel presence in secured areas, or pair the device with a mobile app or host machine. This expands the use cases to include access control and operational logging.

The housing of the device is designed for durability and environmental resistance. In one preferred embodiment, it complies with IP67 or MIL-STD-810 standards, allowing operation under harsh weather, submersion, shock, or vibration conditions. The device may also include tamper-evident seals, RFID serial tags, or unique visual identifiers to support asset control, auditing, or inventory traceability.

In multi-device implementations, the system includes a centralized control platform capable of managing, locating, and logging data from a fleet of tracking modules. This platform may be cloud-based or locally hosted and supports role-based access control, real-time map overlays, anomaly detection algorithms, and compliance reporting functions. In one example, a logistics company may track all high-value shipments using the system, with exception reports generated for delay, shock, or deviation events.

Referring to FIG. 1, illustrating a block diagram of the trackable device for real-time tracking, secure identification, and tamper resistance in high-security use cases. The trackable device 112 is configured to house or fix in the cavity of the personal item or object of the user, for instance, the cavity is formed by structural modifications or designed-in voids within the grip frame of the firearm. The cavity is engineered to conform closely to the outer dimensions of the trackable device, which includes a hardened or ruggedized outer housing to protect internal electronics from shock, recoil, vibration, and extreme temperatures typically experienced during weapon operation and storage.

The internal architecture of the trackable device 112 includes a multi-layered highly secure electronics module 406, engineered to meet military-grade standards of resilience and data protection. This module 406 consisting of a military-grade microcontroller or secure element (SE) built for high-assurance environments, that handles encrypted communication protocols, robust device authentication, and dynamic identity management. The module supports AES-256 encryption or comparable cryptographic standards, ensuring that the data remains tamper-proof and confidential across BLE, UWB, and optionally over secure mesh radio or private military radio frequencies. This anticipates high-threat scenarios, making it suitable not only for consumer use but also for deployment in mission-critical or sensitive field operations where uncompromising security is non-negotiable.

A tamper detection subsystem 408 is provided adjacent to the housing surface and includes one or more sensors such as micro-electromechanical (MEMS) pressure switches, conductive epoxy traces, or light-sensitive sensors configured to trigger upon unauthorized access attempts. If the firearm handle is opened or the trackable module is disturbed, these sensors generate an electrical event that can be logged, transmitted, or used to activate defensive features, such as disabling communication or initiating data wipe sequences.

The power source 312 is embedded beneath the secure electronics and comprises either a rechargeable lithium battery or a solid-state power cell rated for long shelf life and rugged operation. The power source 312 may be supplemented with energy harvesting components, such as piezoelectric harvesters embedded within the grip to convert recoil or motion into electrical charge, thereby extending operational life without external charging requirements.

The Antennas 218 are strategically routed within the handle's interior, using isolated antenna lines or embedded conformal antennas that avoid interference with the weapon's metal components. The BLE and UWB antennas are configured for near-field and mid-range secure communication, facilitating short-range tracking and encrypted handshaking between the weapon and authorized devices such as command units, access gateways, or biometric wearables.

The trackable device 112 further comprises a biometric authentication module 414 optionally located near the exterior grip surface, which may comprise a fingerprint sensor or capacitive skin contact pad. The biometric authentication module 414 enables identity-based access or unlocks features and links the weapon's readiness state to the presence of an authorized user. When the sensor detects a match, it sends a signal to the secure element to activate weapon usage or remove digital locks on the firing system, depending on the integration level.

The communication interface module 416 within the trackable device 112 comprises the Bluetooth module 220, the UWB transceiver module 302, and the NFC module 306 which support proximity-based command handshakes. For instance, the firearm may activate only when within a trusted zone defined by authorized personnel, a paired smart badge, or a base station. The communication interface module 416 may also feature a “last known location” logging system, recording GPS data when available or UWB-derived spatial coordinates for precise indoor location capture.

In an embodiment, all data transmissions are logged in a tamper-proof memory 318 utilizing write-once or blockchain-backed secure memory, ensure the integrity and permanence of critical data. This forensic-grade memory architecture enables the creation of a forensic audit trails that is resilient against tampering, spoofing, or unauthorized access. The memory 318 stores metadata related to weapon usage, geolocation history, tamper attempts, user authentication events, and battery state transitions. This level of traceability not only supports post-incident forensic investigations but also elevates operational transparency and accountability, making it ideally suited for deployment in high-security, law enforcement, or military applications where data integrity is paramount.

The trackable device 112 may be provided with an external access port, concealed behind a gasket panel within the firearm handle, to allow secure maintenance or device configuration. The external access port comprises a magnetic charging port, data sync connection, or firmware update interface, typically accessible only with specialized tools or biometric authorization.

The trackable device 112 is enclosed using a shock-absorbing material, such as thermal insulators or elastomeric barriers, to prevent interference with firearm function while maintaining device survivability under operational stress. Materials are selected to be non-conductive, non-corrosive, and resistant to lubricants or cleaning agents commonly used with firearms.

The system enables secure, tamper-evident, and identity-aware integration of tracking technology within lethal equipment, offering an advanced layer of control, accountability, and traceability in security-critical environments. The system ensures that tracking data, user authentication, and device integrity are maintained even under extreme physical and environmental conditions.

FIG. 2 shows an exploded view of the internal architecture of the modular trackable device 112, clearly illustrating the arrangement and interconnection of its principal internal components. The exploded representation highlights the modularity, compact layering, and integration strategy that collectively enable the device to deliver robust tracking, sensing, and communication functionality within a minimal footprint.

The trackable device 112 is securely housed within a cavity formed in a personal item or object, such as eyeglasses, rifles, helmets, chargers, apparel, containers, and personal accessories. The cavity may be precision-milled or injection-molded into the arm during manufacturing and is dimensioned to snugly accommodate the body of the trackable device 112 without compromising the structural integrity or aesthetics of the personal item or object. The trackable device 112 may be inserted during assembly or designed to be retrofittable, depending on the embodiment.

The trackable device 112 has a housing, which can generally be a rectangular or oval enclosure with rounded edges for ergonomic handling and secure mounting. The housing assembly is exploded in layers to reveal top and bottom covers, internal shock-damping structures (e.g., elastomeric inserts or foam buffers), and electromagnetic shielding layers. The top cover may contain translucent windows or embedded indicator elements (e.g., LEDs) for visual feedback, while the bottom cover may contain mechanical or magnetic coupling interfaces that enable the device to attach to host objects or mounting brackets.

The outer casing is composed of durable, lightweight material such as polycarbonate, ABS composite, or a metal-polymer hybrid, and is optionally coated with an anti-abrasion, UV-resistant surface finish. The trackable device 112 includes a top surface 320 which can have a visual indicator, such as a multi-color LED or e-ink display, for providing status feedback to the user. This surface may also incorporate a tactile or capacitive button configured to trigger manual functions such as pairing, location pinging, or mode switching. The button is recessed or flush with the housing to avoid accidental activation and improve impact resistance.

Along one side or edge of the trackable device 112, a port or opening may be visible, which optionally serves as a diagnostic interface, wired charging port, or sensor opening (e.g., for microphones, pressure sensors, or environmental sensors in certain embodiments). Adjacent to the edge, or optionally along the perimeter, one or more fastening features are illustrated. These may include magnetic couplers, adhesive backing, screw holes, latching rails, or strap loops, allowing the device to be mechanically or magnetically affixed to various host objects.

At the core of the assembly is a multi-layered printed circuit board (PCB) assembly 308, which serves as the central structural and functional platform. This PCB assembly 308 hosts and interconnects all critical electronic subsystems, including a processor 202, which may comprise a low-power microcontroller or a microprocessor with embedded firmware responsible for managing device operations, communication protocols, sensor data processing, and power management routines.

The compact printed circuit board (PCB) 308, which hosts a low-profile system-on-chip (SoC) integrating the BLE module, UWB transceiver, GPS receiver, and NFC controller. These components are arranged in a stacked or side-by-side configuration to minimize vertical height and optimize space within the narrow confines of the temple arm.

In certain embodiments, the processor 202 may further include secure enclave functionality for encrypted data handling and over-the-air (OTA) firmware authentication.

Attached to the PCB 308 are a plurality of wireless communication modules, including a Bluetooth module 220, an Ultra-Wide Broadband (UWB) transceiver module 302, a Global Positioning System (GPS)/GNSS receiver module 304, and an NFC module 306. Each module is arranged to optimize signal integrity and reduce electromagnetic interference. These modules enable the device to interface with mobile devices, peer devices, smart infrastructure, and satellite systems for precise indoor and outdoor positioning, short-range and long-range communication, and near-field interactions.

Adjacent to these modules, antennas 218 are integrated. These antennas 218 are optimized in shape, length, and position for the specific frequency bands used by BLE, UWB, GPS, and NFC communications. In certain embodiments, these antennas may be printed on a flexible PCB substrate or etched into the enclosure to conserve space and enhance signal transmission in compact form factors. Advanced versions may utilize antenna diversity or MIMO configurations for enhanced performance.

The trackable device 112 further includes an integrated power source 312, typically embodied as a thin-film lithium-polymer rechargeable battery or a coin cell battery, depending on the size and power profile of the device. The power source 312 is disposed adjacent to or beneath the PCB. The batteries are electrically connected via micro-connectors or flex cables and may include integrated protection circuitry. In certain embodiments, the power source supports inductive charging through a receiver coil to enable wireless charging when placed on a charging pad or connected to a magnetic charging cable. The power source is operatively coupled with a power management module 314 that regulates charging, and voltage supply to components, and may include support for wireless charging coils or energy harvesting mechanisms, such as solar or kinetic inputs in certain embodiments.

A sensor 316 is also mounted on the PCB or connected via secondary boards. This suite may include an inertial measurement unit (IMU) comprising a 3-axis accelerometer, 3-axis gyroscope, magnetometer, and altimeter/barometer which enables motion and orientation tracking for activity detection, gesture control, or movement-based event triggering, along with optional sensors such as temperature, humidity, proximity, and ambient light sensors. In security-sensitive applications, a tamper detection sensor or physical intrusion switch may be included to detect unauthorized access or removal of the device. The sensors 316 may assist in determining when the device is worn, detecting falls, or enabling hands-free interactions with other smart systems.

The device comprises a non-volatile memory module 318, such as flash memory or EEPROM, used to store firmware, usage logs, location history, device identifiers, encryption keys, and configuration data. This memory may be hardware-encrypted and accessible only through authenticated processes.

The modular nature of the components enables scalability and configurability, allowing OEMs or system integrators to selectively include or exclude modules (e.g., removing the GPS module for indoor-only use cases, or adding secure memory for military applications) without altering the overall mechanical form factor.

In an embodiment, thermal insulation and shock-absorbing materials such as silicone gaskets or elastomeric pads may be interposed between the trackable device 112 and the cavity walls to protect against mechanical stresses during handling or user activity. These materials also aid in acoustic isolation if the device includes haptic feedback modules.

An optional tamper detection mechanism, such as a pressure-sensitive switch or Hall-effect sensor, may be included to monitor unauthorized access or removal of the trackable device 112 from the personal item or object. Upon detecting tampering, the trackable device 112 may trigger an alert, lockout tracking functionality, or erase sensitive stored data depending on the security policy configured.

The trackable device 112 is sealed within the object using a removable or permanent cover, which may be ultrasonically welded, clipped, or adhesively bonded, depending on whether field-servicing or battery replacement is anticipated.

The tracking system supports a range of intelligent features designed to enhance user experience and device recovery reliability. The associated application whether a native OS interface or a proprietary cross-platform app offers an interactive map interface that displays the device's last known or real-time location, using standard, satellite, or 3D views using AR. In particular the system leverages augmented reality (AR) to provide an immersive and intuitive tracking experience. The AR interface may integrate additional contextual information such as nearby landmarks or signal strength indicators to further assist in precise localization and recovery. Additionally, the users can select any registered product to view detailed information, including battery level, sharing status, and precise navigation tools. For devices with UWB, the interface provides close-range directional guidance and distance measurements to guide the user to the device.

The sharing feature allows device owners to grant access to specific trusted individuals, enabling them to view the location or control certain aspects of the device. Sharing permissions and access to the device can be managed from within the app, including viewing a list of all users with shared access, adjusting permission levels, and revoking access at any time. This functionality is particularly useful for families, teams or organizations, tracking shared items, such as keys, bags, tools, etc.

Lost Mode is a critical function that locks the device to the owner's account and activates passive recovery options. Once enabled, if the device comes within Bluetooth range of any compatible smartphone on the global tracking network, the owner is notified with updated location data. Additionally, NFC becomes active to display a finder's message. To enhance reliability, users can also enable “Notify When Left Behind” alerts, which generate a smartphone notification when the device is no longer detected within a defined proximity or geofence area, preventing accidental loss in transit or at public places.

In some implementations, tamper detection mechanisms may be included to monitor for unauthorized physical access to the internal components of the tracking device. This can trigger a tamper event notification or disable tracking until verified. To ensure security and privacy, all data exchanges are encrypted end-to-end, and user identity is protected by anonymized relays when other phones assist in location detection. Ownership locking prevents unauthorized resets, requiring user verification before impairing or reassigning a device.

Referring to FIG. 3, an exemplary environment 200 depicting connection between a user device 102 and a trackable device 112 is shown, in which the user device 102 can be any portable electronic device, such as a smartphone, tablet, or smartwatch etc., equipped with a display screen and a user interface. The environment 200 exemplifies a comprehensive tracking system where the trackable device 112 and the user device 102 work in tandem to provide robust, real-time location tracking and management, ensuring users can easily locate and manage their valuable items. The user interface of the user device 102 is configured to interact with the trackable device 112 through a processor and an application or a built-in software integrated with the existing operating system's Bluetooth tracking network.

The trackable device 112 can be but is not limited to, a small, portable device designed to easily attach to personal items of the user such as keys, wallets, bags, eyeglasses, rifles, helmets, chargers, apparel, containers, or even pets. The trackable device 112 comprises a chipset configured with multiple advanced technologies. The chipset comprises a Bluetooth module for enabling wireless communication with the user device 102 antennas, and location positioning modules such as UWB, and GPS. The trackable device 112 pairs with the user device 102 via the user interface. This pairing process allows the trackable device 112 to integrate seamlessly with the Bluetooth tracking network of the user device 102, enabling a range of functionalities. By using a combination of Bluetooth and GPS technologies in both the user device 102 and trackable device 112, the device can be tracked globally within Bluetooth range and beyond. The trackable device 112 reports its location to the user device 102, which is then displayed on the user interface. The user interface can display the location of the trackable device 112 on a map, which can be viewed in 2D, 3D, and satellite views, showing the last or updated location of the device. Users can share the location information and control tracking functions with other users via the user interface. The trackable device 112 supports wireless charging from a plurality of charging devices.

The trackable device 112 may further comprise an Ultra-Wide Broadband (UWB) device for precision tracking within a precise range, providing more accurate location information. The device may also comprise a Near-Field Communication device to obtain specific information from the trackable device 112. When within Bluetooth range, the trackable device 112 can emit sounds to aid in locating it. The chipset allows the creation of alerts or sounds to locate multiple trackable devices simultaneously. The user interface notifies the user if an unknown trackable device is nearby, preventing unauthorized tracking.

A critical component of the trackable device 112 is that the Bluetooth Low Energy implementation can work on the Generic Attribute Profile (GATT) protocol to facilitate efficient and standardized data exchange between the tracking device 112 and connected user applications. The GATT protocol serves as the foundation for organizing and accessing device services, characteristics, and descriptors in a hierarchical structure that enables seamless communication across diverse field such as managing inventories or military squad management. The trackable device 112 implements custom GATT services specifically designed for, reverse searching, location data transmission, device status reporting, configuration management, and security credential exchange, while maintaining compatibility with standard Bluetooth services for interoperability with existing ecosystem applications and third-party tracking platforms.

The GATT-based architecture enables dynamic service discovery and real-time data streaming through optimized characteristic notifications and indications, allowing the trackable device 112 to efficiently transmit location coordinates, sensor readings, battery status, and alert conditions to connected devices while minimizing power consumption through intelligent connection interval management and data prioritization. Furthermore, the implementation incorporates GATT security features including authentication, authorization, and encryption at the characteristic level to ensure that sensitive tracking data, device configurations, and ownership credentials are protected during transmission, while supporting role-based access control mechanisms that allow different user privileges for device management, location access, and configuration modifications through distinct GATT service hierarchies.

This embodiment enables a distributed peer-to-peer tracking network where individual trackable devices can function as communication nodes and command relays, eliminating dependency on centralized servers, internet connectivity, or GPS-based location services for basic device interaction and response functionality. The mobile application serves as the primary control interface, maintaining simultaneous GATT connections with multiple trackable devices and orchestrating device-to-device communication protocols that allow one tracking device to initiate discovery and activation sequences on nearby devices within its Bluetooth communication range. When a user initiates a “find” command through the mobile application, the system intelligently selects the most appropriate trackable device based on proximity, signal strength, and last known location data to serve as the triggering device, which then performs an active Bluetooth scan to locate and establish direct communication with the target device.

The triggering mechanism utilizes custom GATT characteristics specifically designed for inter-device communication, enabling the transmission of authenticated command packets that bypass traditional pairing requirements while maintaining security through encrypted device-specific tokens and time-limited authorization codes. Upon receiving a valid triggering command via the Bluetooth GATT protocol, the target trackable device immediately activates its response actuator, which may include audio alerts, LED indicators, vibration motors, or combination response patterns, allowing users to locate misplaced or hidden objects through audible, visual, or tactile feedback mechanisms. This offline-capable architecture ensures operational continuity in environments with limited or no internet connectivity, while the distributed communication model provides redundant pathways for device activation, as multiple trackable devices within range can serve as potential triggering nodes, creating a resilient mesh-like network topology that enhances system reliability and coverage area.

The mobile application is configured to provide robust real-time monitoring of the asset's proximity, ensuring continuous protection against unauthorized movement or accidental misplacement. Specifically, it employs proximity sensors or wireless communication (such as Bluetooth or RFID) to maintain a virtual tether between the asset and a paired device. If the asset moves beyond a predefined range—unless it is within a user-defined safe zone—the application immediately triggers an alert to notify the user. This safe zone logic allows for intelligent alert suppression in trusted locations such as the user's home or workplace, thereby minimizing false alarms while ensuring vigilance in unfamiliar or high-risk environments.

In addition to proximity monitoring, the application tracks the asset's live location using GPS or similar positioning technologies and displays this data on an interactive map within the user interface. The application further enhances security by implementing a geo-fence protocol, whereby virtual boundaries are drawn around specific geographical areas. When the asset enters or exits these geo-fenced zones, the application automatically sends out alerts to preconfigured recipients or the user. This functionality is particularly useful for monitoring high-value assets, children, or sensitive equipment, ensuring that any unauthorized or unexpected movement is instantly flagged for corrective action.

FIG. 4 illustrates an exemplary diagram representing the geofencing functionality of the modular trackable device 112. The figure visualizes the use of proximity thresholds, separation alerts, and dynamic location updates that are triggered based on user-defined virtual boundaries (geofences). The geofencing feature is a critical security and usability enhancement that enables real-time situational awareness and boundary-aware device behavior, particularly in applications involving asset protection, child safety, military logistics, and enterprise inventory management.

The illustration in FIG. 4 depicts a map-like user interface or an augmented spatial visualization overlaid on a smart device screen. It shows multiple concentric circles centred around a user's device 102 representing safe zones or a designated reference point (e.g., home, office, vehicle). These zones represent user-defined geofence perimeters, such as a 5-meter proximity alert, a 20-meter warning threshold, and a 50-meter maximum range beyond which escalation protocols are activated.

A tracked object, such as a wearable, firearm, or valuable personal item embedded with the modular tracking device, is shown as a discrete marker within or outside these boundaries. The trackable device transmits its location continuously or periodically using onboard communication modules (BLE, UWB, GNSS, etc.) to the user's mobile application or cloud backend.

When the device crosses a user-defined geofence, the system detects this event using real-time GPS triangulation and/or proximity data (e.g., signal strength or round-trip time from BLE/UWB). For example, if the device moves beyond the 20-meter perimeter without authorization, the system triggers an automatic alert on the user's smartphone (e.g., sound, vibration, or pop-up notification).

Additionally, the system may implement adaptive thresholds based on contextual settings or dynamic environments. For instance, in a densely populated area, the minimum alert zone may shrink to prevent nuisance alarms, whereas in high-risk areas (e.g., airports, military zones), the alert threshold may expand, and automatic lockdown or signal jamming features may be invoked to prevent device tampering or unauthorized transfer.

The supports multi-zone tracking, allowing the user to assign different alert behaviors to different zones. For example, an inner zone may permit full device functionality, a middle zone may enable location logging but restrict transfer or pairing actions, and an outer zone may trigger security protocols such as device lockdown, location beaconing, or tamper monitoring.

In one embodiment, the geofencing feature operates in tandem with motion sensors and orientation data to determine whether the device is in motion, idle, or experiencing irregular movement suggestive of theft or unauthorized handling. The logic engine can infer behavioral patterns, such as continuous displacement without user proximity, to escalate alerts or notify designated contacts.

The system can further be programmed with schedule-based geofences, where zones are enforced only at specific times (e.g., during school hours, night shifts, or patrol periods). This temporal aspect adds an additional layer of customization and relevance for both personal and organizational use cases.

In advanced configurations, the user interface enables remote management of geofence rules, such as modifying zone radius, sensitivity, or alert type via cloud-based dashboards. This depicts a UI element for creating or editing zones, selecting linked devices, and defining response protocols upon breach events.

Furthermore, the modular trackable device system may optionally integrate with third-party services, such as municipal safety networks, family locator platforms, or enterprise fleet management tools, to synchronize geofence status and react collaboratively to device separation events.

The functionality embodies a robust, location-aware security layer for the modular trackable device. It ensures that movement beyond authorized spatial boundaries results in real-time feedback and actionable responses, significantly enhancing the practical utility and operational control over tracked assets.

FIG. 5 illustrates the trackable device 112 configured to interface with an augmented reality system embedded in or coupled to a helmet, enabling real-time navigation, team coordination, and object localization functionalities. The helmet 500 is designed to incorporate a compartment or docking recess specifically adapted to house the trackable device 112. This compartment may be molded into the helmet shell, integrated into its lining, or affixed externally, depending on application requirements. The trackable device 112 is securely fixed using mounting brackets or magnetic lock-in assemblies, allowing quick replacement or modular upgrades while ensuring mechanical stability during use.

The trackable device 112 in the helmet 500 comprises the communication interface module 416, which includes the Bluetooth module 220, the UWB transceiver module 302, the GPS/GNSS module 304, and the NFC module 306. The communication interface module 416 interfaces wirelessly with other team members' helmets, smart badges, base stations, or command systems. In a military or field deployment scenario, the BLE and UWB modules allow low-latency positional triangulation with centimeter-level precision, facilitating coordinated team movement and spatial awareness.

The GPS module 304 provides macro-location data, while the UWB transceiver module 302 supports fine-grained indoor positioning, particularly useful in GPS-denied environments like underground tunnels, dense structures, or combat zones. The helmet's internal circuitry connects with this communication module to relay navigational data to an AR display 502 mounted on or within the helmet visor or optics.

The AR display 502 comprises a heads-up display (HUD), smart visor, or waveguide-based projection system that overlays directional cues, object labels, waypoint arrows, or teammate positions on the user's visual field. The AR display 502 receives continuous updates from the trackable device 112, enabling the user to receive spatial orientation guidance, proximity warnings, or status updates on tagged assets or personnel.

The antennas 218 embedded in the helmet are directional antennas for BLE (Bluetooth Low Energy) and UWB (Ultra-Wide Band) signals, arranged to optimize omnidirectional coverage while minimizing interference from the user's head or other metallic objects. The antennas are tuned to perform in proximity to the human body and are electrically isolated using dielectric layers to prevent signal attenuation.

The trackable device 112 is also provided with sensors 316 such as barometric pressure sensors, thermal sensors, inertial measurement units (IMUs), and magnetic compasses integrated within the trackable device. The sensors 316 augment AR feedback by providing contextual information like elevation changes, directional orientation, temperature thresholds, and tilt angles, all of which can be displayed or logged in real-time.

The power source 312 located either in the helmet or the trackable device 112 itself provides energy to both the AR interface and the tracking subsystem. The power source 312 can be modular, which is based on lithium-ion or graphene-enhanced battery packs and optionally integrates solar panels or kinetic harvesters (e.g., from head motion) embedded on the helmet's exterior to passively recharge during daylight or physical movement.

In an embodiment, the trackable device 112 also supports biometric feedback sensors, including heart rate, EEG, or skin temperature sensors, for health monitoring in mission-critical environments. The data is transmitted via the trackable device's communication modules to command centers, allowing real-time status checks of personnel in the field and correlating physiological data with location-based metrics. In an embodiment, the trackable device 112 further comprises a plurality of AR-interactive features such as voice command recognition or gesture tracking systems that work in conjunction with the helmet's interface to control visual layers, zoom, object highlighting, or alert acknowledgment. These features enhance user control and reduce manual interaction, essential for hands-free operation in high-stress or hazardous environments.

In an embodiment, the trackable device 112 further integrates security features such as encrypted communication, device pairing with authenticated headgear, and tamper detection. If the helmet or the trackable device is removed without authorization or if the embedded module is disturbed, tamper events are logged and alerts are transmitted to central systems.

The system enables seamless convergence of positional awareness, team coordination, and augmented reality visualization, dramatically improving situational awareness, safety, and mission efficiency in dynamic environments. Whether navigating a collapsing building in a rescue operation or coordinating fire team movement in combat, the system offers a powerful, real-time feedback loop between physical location and digital augmentation.

FIG. 6 is a block diagram of a trackable device system 100 illustrating components of a trackable device system, in accordance with an embodiment of the present invention. The trackable device system 100 comprises a user device 102 and a trackable device 112 communicably coupled to each other through a communication network 208. The user device 102 may include a processor 202, a memory 204, and an input/output (I/O) device 206.

In an embodiment, examples of processor(s) 202 may include but are not limited to, an Intel® Itanium® or Itanium 2 processor(s), AMD® Opteron® or Athlon MP® processor(s), Motorola® lines of processors, Nordic, Nvidia®, FortiSOC™, system on a chip processors or other future processors.

In an embodiment, the memory 204 store multiple instructions which are executable by the processor 202, to enable device tracking, as discussed in more detail below. The memory 204 may be a non-volatile memory or a volatile memory. The memory 204 can store a single module or a combination of different modules to track devices. Examples of non-volatile memory may include but are not limited to, a flash memory, ROM, a Programmable ROM (PROM), Erasable PROM (EPROM), and Electrically EPROM (EEPROM) memory. Further, examples of volatile memory may include but are not limited to, Dynamic Random Access Memory (DRAM), and Static Random-Access Memory (SRAM).

In an embodiment, the I/O device 206 comprises a variety of interface(s), for example, interfaces for data input and output devices. The I/O device 206 facilitates instructions given by a user communicating with the computing device 102. The I/O device 206 can be wirelessly connected to the computing device 102 through wireless network interfaces such as Bluetooth®, infrared, or any other wireless radio communication. In an embodiment, the I/O device 206 can be connected to a communication pathway of one or more components of the computing device 102, that facilitates the transmission of provided input instructions and output results of data generated by various components such as, but not limited to, processor(s) 202 and memory 204.

In an embodiment, the communication network 208 can be any type of wireless network or a combination of networks, such as an Ethernet IP network, intranet, LAN, WAN, or MAN. The communication network 208 supports various wired and wireless communication protocols, including TCP/IP, UDP, HTTP, FTP, ZigBee, EDGE, IEEE 802.11, Li-Fi, 802.16, 802.11s, 802.11g, multi-hop communication, wireless AP, device-to-device communication, cellular communication protocols, and Bluetooth.

The method for registering the trackable device 112 initiates with a user obtaining a new trackable device 112 that includes an embedded Bluetooth module. The user downloads the mobile application (IOS, Android, or other) to register the new trackable device 112. The user pairs the trackable device 112 with their mobile device via Bluetooth signals and under the control of the mobile application. In some embodiments, the mobile application (in communication with a server or service platform) determines if the new trackable device 112 has been registered before. If the trackable device 112 has not been registered before, then the application asks the user to provide his personal information and links the user with his new trackable device 112 using the MAC address of Bluetooth hardware or another identifier. The user is asked to configure alerts in case the trackable device 112 is located away from the mobile device. For example, the alert may be divided into 3 groups, depending on the RSSI (Received Signal Strength Indicator) of the emitted signal. If the trackable device 112 has been registered before, then the mobile application verifies that the trackable device 112 has been registered by the user. In this case, the user may continue using the trackable device 112. However, if the trackable device 112 has been registered by another user, then the mobile application generates an alert and informs the user that the frames should be returned to the place of purchase or another indicated vendor.

FIG. 7 represents a system-level diagram of the communication architecture of the trackable device 112, illustrating the interconnected framework between the trackable device 112, a user device 102 (such as a smartphone), a cloud server 610, and a third-party tracking network 620, such as Apple's Find My™ Network, Google's Find My Device™, or similar distributed crowdsourced tracking ecosystems. The communication pathways between these components enable robust, real-time geolocation, device management, data logging, alert notification, and remote control functions.

At the core of the system is the trackable device 112, which houses a communication interface module 416 including Bluetooth Low Energy (BLE), Ultra-Wide Broadband (UWB), Global Positioning System (GPS), and Near Field Communication (NFC) modules. The communication modules enable the device to interface directly with local devices (such as smartphones) and indirectly with cloud services and global tracking infrastructures.

The user device 102 serves as a local hub for interfacing with the trackable device 112. Communication is primarily conducted via BLE for proximity-based control, configuration, and status reporting, and optionally via NFC for tap-to-connect pairing or secure authentication. Through a mobile application 602, the smartphone collects data from the trackable device, such as location coordinates, motion patterns, environmental sensor readings, battery level, tamper status, and user interactions.

The mobile application further provides the user with a graphical user interface (GUI) for interacting with the device. This includes functions for real-time tracking visualization, geofencing configuration, alert management, remote activation/deactivation, and log history access. User authentication through biometric verification or password validation may be employed to prevent unauthorized access to device control or location data.

Collected data is transmitted securely from the smartphone to a cloud server 610 using end-to-end encrypted communication protocols. The cloud server provides centralized data aggregation, analytics, and storage, while also enabling remote device management and synchronization across multiple user profiles or fleet-based deployments.

The cloud server may further implement AI-based analytics engine 612 to process positional trends, user behavior, anomaly detection, or predictive location mapping. These insights are relayed back to the user in the form of alerts, efficiency scores, or usage reports. In enterprise or military contexts, the cloud server may also interface with a central command system or inventory management platform 614 to track large-scale deployments of the devices.

Importantly, the cloud infrastructure can interface with third-party tracking networks 620. The third-party tracking network 620 may include but is not limited to Apple's Find My™ Network, Google's Find My Device™, Samsung SmartThings™, or other Bluetooth-based crowdsourced networks that allow millions of connected smartphones and devices to anonymously detect the presence of a lost or stolen trackable device.

When the device is reported lost, the cloud server 610 sends a message or a ping to these third-party tracking networks via their respective developer APIs. Any nearby third-party device (e.g., an iPhone or Android phone with background BLE scanning) that detects the lost trackable device's beacon can relay its location back to the cloud server 610 securely and anonymously, which then updates the user's app with the device's most recent known coordinates.

In some embodiments, the trackable device 112 may support two-way communication, allowing it to receive commands from the cloud server 610 or mobile application 602. These may include instructions to emit an audible alarm, disable tracking, enable stealth mode, broadcast a distress beacon (in SOS scenarios), or even trigger a tamper alert.

In an embodiment, the system may support time-based or location-based automation rules. For example, the trackable device 112 can be configured to automatically enter low-power mode during nighttime, send alerts when leaving a geofenced zone, or notify guardians when movement resumes after a period of inactivity.

For security, all data transmissions, including BLE pairing, server sync, and third-party updates, employ end-to-end encryption, device authentication, and dynamic session key exchange to prevent spoofing, man-in-the-middle attacks, or data leakage. The trackable device and mobile application may also support remote wipe functionality in the event of theft or loss.

This configuration enables seamless integration across personal, enterprise, and crowdsourced tracking environments. It provides scalable, multi-layered tracking intelligence with real-time interactivity, privacy controls, and redundancy that enhance device recoverability, fleet visibility, and situational awareness across diverse use cases.

FIG. 8 is a flowchart showing a method illustrating the ownership binding and transfer process for the modular trackable device using a secure, decentralized blockchain registration protocol, robust encryption mechanisms, and authenticated pairing steps. The method ensures tamper-resilient traceability, secure ownership validation, and auditable transfer of control, making the device suitable for sensitive applications such as military gear, enterprise inventory, and consumer anti-theft systems.

The process begins at step 802, where the trackable device 112 is activated for the first time or factory reset to an unbound state. In this state, the trackable device 112 is unregistered and cannot transmit location data to any user account until a legitimate pairing process is completed. This ensures that unauthorized access or premature tracking is not possible prior to verified ownership binding.

In step 804, a user initiates a pairing request via a secure mobile application or management platform. This request includes a unique device identifier (such as a serial number or embedded secure hardware ID), the user's account credentials, and optionally, biometric authentication or multi-factor verification.

Step 806 introduces the blockchain-based ownership registration. Upon receipt of the pairing request, the system generates a transaction on a decentralized blockchain ledger, wherein the trackable device's unique cryptographic fingerprint (e.g., a hardware-anchored public key or secure element signature) is bound to the user's public key or blockchain address. This ensures an immutable recording of the initial ownership claim.

In step 808, the system performs a mutual key exchange between the device and the user's authenticated device or cloud account. The process uses end-to-end encryption protocols (e.g., Elliptic Curve Diffie-Hellman) and secure over-the-air handshake standards (such as BLE Secure Connections or UWB pairing frameworks). Both parties verify the legitimacy of the connection through cryptographic challenge-response mechanisms.

Once the handshake succeeds, step 810 finalizes the pairing and encryption key derivation. A unique session key or long-term symmetric encryption key is derived, stored securely within the device's TPM (Trusted Platform Module) or secure enclave, and also retained in encrypted form on the user's secure profile. This key governs all future authenticated interactions between the user and the device.

Step 812 ensures the pairing metadata and ownership status are replicated to a secure cloud ledger (which may mirror or interact with the blockchain system), enabling global synchronization and loss recovery. In the event the user loses access to their device or changes platforms, the server can assist with recovery while preserving ownership integrity.

In step 814, the system offers transfer protocol options for securely reassigning the device to another verified user. This process may be initiated by the original owner and involves revoking the current encryption keys, verifying the recipient's credentials, and generating a new blockchain transaction that transfers the ownership binding to the new public address or account.

To avoid unauthorized transfer, step 816 introduces optional biometric confirmation or physical validation (e.g., pressing a hidden pairing button on the device or tapping with an NFC-enabled badge). This dual verification step confirms the owner's intent to relinquish control.

After successful transfer, step 818 ensures the device is securely wiped of previous user data, dissociated from the former owner's tracking app or cloud access, and re-initialized for pairing. A new blockchain transaction is recorded to reflect the latest ownership change, providing a tamper-evident audit trail.

Step 820 optionally logs the entire sequence, including timestamps, device serial, public keys involved, and transfer context, in a compliance-grade audit log for enterprises or defense applications where asset chain-of-custody is critical. This ensures accountability and legal traceability throughout the device lifecycle.

The process reinforces ownership authenticity, device security, and operational control through a robust combination of blockchain immutability, cryptographic integrity, and multi-factor pairing protocols. It ensures that the trackable device cannot be cloned, hijacked, or misused by unauthorized parties and that every lifecycle event (from first activation to final decommissioning) is securely recorded.

In an embodiment of the present invention, the trackable device is integrated with a solar panel to power the trackable device. The solar panel may be rigid or flexible in form and is electrically connected to the device's internal rechargeable power supply, such as a lithium-ion or solid-state battery, via a power management circuit that handles solar energy harvesting, voltage regulation, and battery protection. The solar panel is configured to provide trickle charging to the internal battery under daylight conditions, allowing the trackable device to operate autonomously for extended periods, even in remote or off-grid environments. The solar-powered trackable devices are suitable for military deployments, search-and-rescue kits, outdoor sports, construction equipment, or emergency supply cases, where access to traditional power sources may be limited.

In an embodiment of the present invention, the system includes a power management module that intelligently switches between solar input and battery storage, optimizing energy usage depending on light availability and system power demand. For instance, during periods of peak sunlight, the solar input powers the device directly while simultaneously recharging the battery. At night or in shaded conditions, the system automatically draws from the battery reserve.

FIG. 9 is a flowchart showing a method for detecting and mitigating unauthorized tracking by the trackable device 112. The system incorporates proactive monitoring algorithms, cross-platform communication mechanisms, and configurable user controls to identify and respond to misuse or stealth tracking events, and is critical in view of increasing privacy concerns around hidden or non-consensual use of location-tracking technology.

At step 902 continuous monitoring of the trackable device's 112 proximity behavior and pairing status is performed. The trackable device 112 is programmed to recognize if it remains persistently near an unauthorized user (i.e., a user other than the registered owner or paired mobile device) over a defined time and distance threshold. This may be determined by detecting repeated interactions with unknown smartphones via BLE, NFC, or other local interfaces.

At step 904, it is evaluated whether the trackable device 112 is being detected by a smartphone that is not registered as the primary or approved secondary user. The system leverages a pairing whitelist, stored locally or synced from the cloud that authenticates valid user devices. If the scanning user device is unrecognized and proximity exceeds a predetermined duration (e.g., 15 minutes or more than 100 meters from the owner's last known location), the device flags a suspicious tracking pattern.

At step 906, the system introduces an anomaly detection algorithm that factors in movement patterns, signal strength, geolocation deltas, and interaction frequency. For example, if the trackable device 112 is consistently seen traveling with a third-party smartphone that has not authenticated with it, the algorithm computes a tracking suspicion score based on criteria such as duration of overlap, proximity consistency, and lack of rightful user presence.

Upon reaching a defined threshold of suspicion, at step 908, the system triggers a silent background alert to the detected smartphone user (i.e., the party potentially being tracked unknowingly). This alert is implemented via native OS-level mechanisms, such as Android or iOS background services, or through a universal alerting app integrated with BLE scanning capabilities. The alert informs the user that an unknown device appears to be moving with them and maybe attempting to track their location.

At step 910, the system provides the alerted user with options to respond, which may include: Playing a sound from the device to locate it; Viewing the device identifier and manufacturer details; Disconnecting or muting the device temporarily; Reporting the incident to relevant authorities or tracking network administrators.

Simultaneously, the owner of the device receives an alert notification via their paired application, informing them that their device may have triggered a privacy warning on another user's smartphone. This two-way transparency allows the rightful user to review potential misuse or confirm a false positive (e.g. if the device was accidentally left in a rideshare vehicle).

At step 912, the system may optionally provide a temporary disabling or stealth mode activation for the trackable device. Depending on the security policies set by the platform, the device may halt broadcasting its BLE/UWB signals, limit GPS logging, or enter a low-power state to cease active tracking. This may be enforced either by the user who received the warning (in privacy-first implementations) or by cloud policies configured by the device owner or manufacturer.

In step 914, the system performs backend analysis and logging, documenting all unauthorized tracking events. This data is uploaded to a secure cloud server, where it can be reviewed by the user, authorities, or platform administrators. In enterprise or military contexts, this may trigger escalations or fleet-level reviews to prevent espionage, insider misuse, or regulatory violations.

At step 916, the system allows for user-configurable remediation actions. These may include: Permanently disabling the device; Resetting device ownership and unpairing all previously connected users; Updating firmware to enhance tracking protections; and Submitting the incident to a public tracking incident registry or privacy watchdog service.

The modular trackable device upholds strong privacy and anti-stalking safeguards, offering users of all roles (such as owners, bystanders, or third-party network participants), a transparent, controllable, and accountable system. By combining device-side detection, user alerts, backend analytics, and dynamic response capabilities, the invention provides a technically enforceable mechanism for unauthorized tracking prevention that aligns with privacy laws and user expectations.

FIG. 10 represents the operational visibility and control through a multi-level, network-connected system architecture unit 1000. The hierarchical structure of military consists of three main levels: Battalion, Unit, and Squad, which further break down into individual soldiers and vehicles. Each level is interconnected using wireless communication technologies such as Bluetooth and other secure channels, ensuring seamless data sharing and command coordination. The battalion oversees multiple units, each unit comprises several squads, and each squad includes individual soldiers and vehicles. This structured approach mirrors real-world military formations and allows for accurate, real-time tracking and management of personnel and assets across all levels.

This system is particularly valuable for military applications like geo-fencing, end-to-end encryption, augmented reality (AR) guidance, and inventory control. Each entity in the hierarchy whether it be a battalion or a soldier has a digital profile. These profiles allow higher command levels to maintain visibility and control over all subordinate units and devices. For example, a battalion commander can monitor the position, communication status, and mission-readiness of all units, squads, and individual soldiers under their command. The profile structure supports centralized policy enforcement such as confidentiality agreements and security protocols, ensuring consistent compliance across the entire organization. This architecture enhances operational security, responsiveness, and mission effectiveness in both peacetime operations and combat scenarios.

Further the trackable device incorporates intelligent location verification algorithms that analyze GPS accuracy metrics, movement patterns, and environmental context to validate location updates before committing changes to the inventory database, thereby preventing erroneous location assignments due to GPS drift, signal interference, or temporary connectivity issues. Additionally, the automated inventory system supports configurable location hierarchies and zone-based categorization, enabling automatic assignment of tracked objects to specific departments, rooms, storage bins, or custody chains based on their reported GPS coordinates, while maintaining comprehensive audit trails that document all location changes, movement patterns, and system-generated inventory updates for compliance and accountability purposes.

The present invention implements a sophisticated multi-tiered access control system that operates across the same network infrastructure while providing differentiated levels of device visibility, control authority, and data access based on user roles, organizational hierarchy, and security clearance levels. The system establishes distinct access tiers including Administrator level with full device configuration and network management capabilities, Supervisor level with limited device monitoring and location access within designated areas or asset groups, Operator level with basic tracking and status viewing permissions for assigned equipment, and Guest level with restricted read-only access to non-sensitive device information. Each access level is cryptographically secured through unique authentication tokens and digital certificates that determine which devices, data streams, and system functions are accessible to individual users or user groups within the shared network environment.

The multi-level access architecture incorporates dynamic permission inheritance and role-based data filtering mechanisms that automatically restrict or expand user capabilities based on contextual factors such as geographic location, time-based access windows, device criticality levels, and operational security requirements. For enterprise and military applications, the system supports compartmentalized access control where users can simultaneously hold different permission levels for different device categories or operational zones, enabling granular security management while maintaining operational efficiency. The network infrastructure maintains separate encrypted communication channels for each access tier, ensuring that sensitive command and control data, high-priority location information, and critical system configurations remain isolated from lower-privilege users while still enabling collaborative tracking and coordination activities within appropriate authorization boundaries.

Various modifications to these embodiments are apparent to those skilled in the art from the description and the accompanying drawings. The principles associated with the various embodiments described herein may be applied to other embodiments. Therefore, the description is not intended to be limited to the embodiments shown along with the accompanying drawings but is to provide the broadest scope consistent with the principles and the novel and inventive features disclosed or suggested herein. Accordingly, the invention is anticipated to hold on to all other such alternatives, modifications, and variations that fall within the scope of the present invention and appended claims.

The invention claimed is:

1. A trackable A trackable device system, comprising:
a housing configured to be integrated with or attached to an asset;
a communication module embedded in the housing configured to wirelessly communicate with a user device over a network through an encrypted communication protocol to prevent unauthorized access;
a tracking module embedded in the housing configured to determine a location data of the asset;
a processor configured to pair with a mobile application on the user device and transmits location data of the asset to the mobile application;
wherein the mobile application is configured to:
monitor proximity of the asset and trigger an alert upon separation unless a predefined safe zone is detected;
track and display location of the asset;
engage a geo-fence protocol and transmit an alert when the asset enters or exits a predefined virtual boundary.

2. The system of claim 1, wherein the communication module includes at least a Bluetooth, Bluetooth Low Energy (BLE), a Wi-Fi modem, a cellular modem, or a combination thereof.

3. The system of claim 1, wherein the tracking module includes at least a GPS, GNSS, a UWB transceiver, a location-based Wi-Fi, or a combination thereof.

4. The system of claim 1, wherein the mobile application track and display location of the asset in 2D, 3D, and augmented reality overlays.

5. The system of claim 1, wherein the geo-fence protocol allows dynamic creation or deletion of boundaries using the mobile application.

6. The system of claim 1, wherein the mobile application is further configured to detect separation from a base station, a host platform, or the user device and log the timestamped location data of the asset on occurring of a separation event.

7. The system of claim 1, wherein the housing further comprises an accelerometer configured to transmit motion data to the mobile application on the user device, the user device transmits an alert when motion of the asset is detected.

8. The system of claim 1, wherein entering or exiting the pre-defined safe zone triggers a status change in the asset, including generation and suppression of notifications.

9. A trackable device system for asset management, comprising:
a housing configured to be attached to an asset;
a communication module embedded in the housing configured to wirelessly communicate with a user device over a network through an encrypted communication protocol to prevent unauthorized access;
a tracking module embedded in the housing configured to determine a location data of the asset;
a memory configured to store a unique identifier for the asset and encrypted log data;
a processor configured to:
establish communication with inventory management platform through a localized encrypted network;
enable communication with one or more pre-authorized assets within the encrypted network;
selectively advertise the presence of the asset to the inventory management platform.

10. The system of claim 9, wherein the memory comprises encrypted flash memory and a secure enclave for storing sensitive data including cryptographic keys and user credentials.

11. The system of claim 9, wherein the memory stores encrypted log data comprising timestamps, geolocations, environmental conditions, and asset state, and is capable of uploading such logs to the secure inventory management platform.

12. The system of claim 9, wherein the asset is registered to a distributed ledger that logs assignments, transfers, and custody status using a blockchain-based infrastructure.

13. The system of claim 12, wherein the distributed ledger is accessible through a secure permissioned blockchain network and provides audit logs for authorized users.

14. The system of claim 9, wherein each of the asset is associated with a unique identifier and assigned to individual users, organizational groups.

15. The system of claim 9, further comprising a RFID or NFC tag embedded in the asset, enabling contactless asset detection and inventory logging.

16. The system of claim 9, wherein system supports multi-tier visibility, allowing role-based access to a plurality of assets across units, teams, or departments.

17. A trackable device system for enabling peer-to-peer detection, the system comprising:
A plurality of trackable devices attached to a plurality of assets, wherein each of the plurality of trackable device comprises a communication module and a tracking module;
wherein the plurality of trackable device communicate using a shared communication protocol Bluetooth GATT with other device;
wherein each of the plurality of trackable device comprises a response actuator configured to perform a predefined physical response;
wherein a first trackable device is configured to detect the presence of a second trackable device within communication range and transmit a command to activate the response actuator on the second trackable device.

18. The system of claim 17, wherein the system further comprises a mobile application in a user device in communication with the plurality of trackable device, wherein the mobile application is configured to:
identify and establish a communication with the plurality of trackable device;
initiate, through the first trackable device, a detection scan for the second trackable device within a communication range;
cause the first trackable device to transmit a triggering command to the second trackable device using the Bluetooth GATT protocol, the command configured to activate the response actuator on the second trackable device;
wherein the triggering occurs without location services or a cloud-based infrastructure.

19. The system of claim 17, wherein the plurality of trackable devices is configured to operate on a same or a different tracking network.

20. The system of claim 17, wherein the response actuator triggers a physical response that includes but is not limited to emitting an audible alert, vibrating or flashing a light.
